(19) United States
(12) Patent Application Publication
(10) Pub. No.: US 2009/0220128 A1
(43) Pub. Date: Sep. 3, 2009

(54) AUTHENTICATION DEVICE, AUTHENTICATION METHOD AND AUTHENTICATION PROGRAM

(75) Inventors: Yuuji IRIMOTO, Akishima-shi (JP); Kei SAKAMOTO, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/364,309

(22) Filed: Feb. 2, 2009

(30) Foreign Application Priority Data
Feb. 29, 2008 (JP) 2008-050947

(51) Int. Cl. G06K 9/00

(52) U.S. Cl. 382/118; 382/296

(57) ABSTRACT

An authentication apparatus for authenticating an authentication target of a user's face includes: a display configured to display an image to authentication target; a camera arranged in the vicinity of the display to take an image of the authentication target; an assist unit configured to output a guide image instructing a user a direction in which to turn in accordance with an attribute of the authenticating; and an image synthesis unit configured to synthesize the image taken by the camera and the guide image output from the assist unit to display a synthesized image on the display.

### CROSS-REFERENCE TO RELATED APPLICATIONS

This application is based upon and claims the benefit of priority from Japanese Patent Application No. 2008-050947, filed Feb. 29, 2008, the entire contents of which are incorporated herein by reference.

### BACKGROUND

1. Field

The present invention relates to an authentication method for a person, and more particularly to an authentication method for a person's face.

2. Description of the Related Art

In using a computer system, it is important to correctly authenticate the user who uses the computer system. Nowadays, the biometrics techniques with biometrical information have been employed to enhance the authentication accuracy. One method is a face authentication method that collates the features of the user's face. In the face authentication method, the user can apply it without a feeling of reluctance, because the user only needs to stand before the camera, though the authentication accuracy may depend on the position or angle of the face.

Therefore, a method for displaying an index for aligning both eyes of the user subjected to face authentication on the screen has been proposed (refer to JP-A-2003-317100).

In making the face authentication for the user, the authentication accuracy may be often varied depending on the position or angle of the face reflected on the camera.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing one example of an authentication device according to an embodiment of the present invention.

FIG. 2 is an exemplary block diagram showing one example of the authentication device according to the embodiment.

FIG. 3 is an exemplary functional block diagram showing one example of the authentication device according to the embodiment.

FIG. 4 is an exemplary view showing an example of guide image according to the embodiment.

FIG. 5 is an exemplary view showing an example of image synthesis according to the embodiment.

FIG. 6 is an exemplary flowchart showing one example of operation flow of the authentication device according to the embodiment.

### DETAILED DESCRIPTION

Various embodiments according to the invention will be described hereinafter with reference to the accompanying drawings. In general, according to one embodiment of the invention, there is provided an authentication apparatus for authenticating an authentication target of a user's face includes: a display configured to display an image to authentication target; a camera arranged in the vicinity of the display to take an image of the authentication target; an assist unit configured to output a guide image instructing a user a direction in which to turn in accordance with an attribute of the authenticating; and an image synthesis unit configured to synthesize the image taken by the camera and the guide image output from the assist unit to display a synthesized image on the display.

According to another aspect of the present invention, there is provided an authentication method for authenticating an authentication target of a user's face including: selecting a guide image instructing a user a direction in which to turn in accordance with an attribute of the authenticating; acquiring a face image of the authentication target; generating a synthesized image from the face image and the selected guide image; and displaying the synthesized image to a user.

According to another aspect of the present invention, there is provided a computer readable storage medium that stores a software program causing a computer system to perform an authentication process for authenticating an authentication target of a user's face, the process including: selecting a guide image instructing a user a direction in which to turn in accordance with an attribute of the authenticating; acquiring a face image of the authentication target; generating a synthesized image from the face image and the selected guide image; and displaying the synthesized image to a user.

### Embodiment

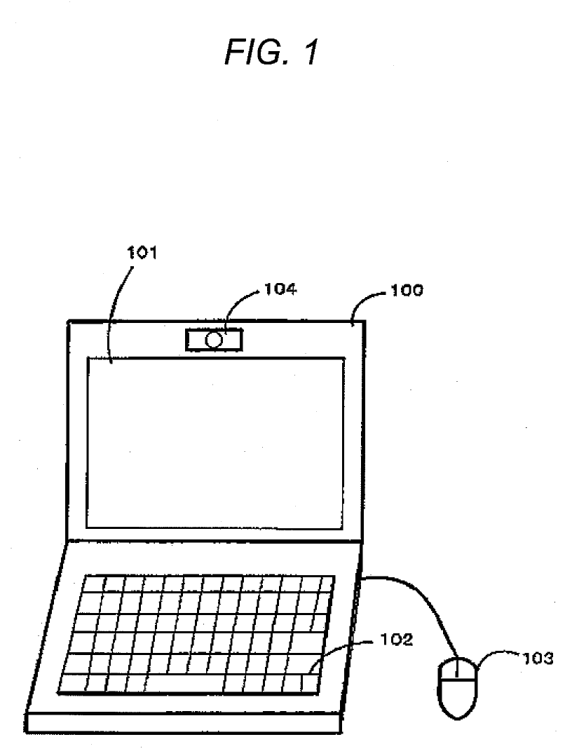

FIG. 1 is a view showing one example of an authentication device according to an embodiment of the present invention. In FIG. 1, a PC 100, a display 101, a keyboard 102, a mouse 103 and a camera 104 are shown.

The PC 100 is a portable personal computer such as a notebook personal computer.

The display 101 is a display unit mounted on the PC 100. For example, it is an LCD (Liquid Crystal Display) in which the PC 100 displays information to the user.

The keyboard 102 is an input unit built into the PC 100. The user of the PC 100 can give any instruction by keying on the keyboard 102.

The mouse 103 is an input unit for moving a mouse cursor displayed on the screen of the PC 100 according to the user's intention. Such input unit is used to point to a predetermined position on the screen and also called a pointing device. Further, it comprises some buttons used for instructing the PC 100 to start a predetermined operation.

The camera 104 is provided on the top of the display 101, and laid to photograph a video of the user who manipulates the PC 100. The camera 104 has a function of converting the video in an opening direction into an electronic signal of image data.

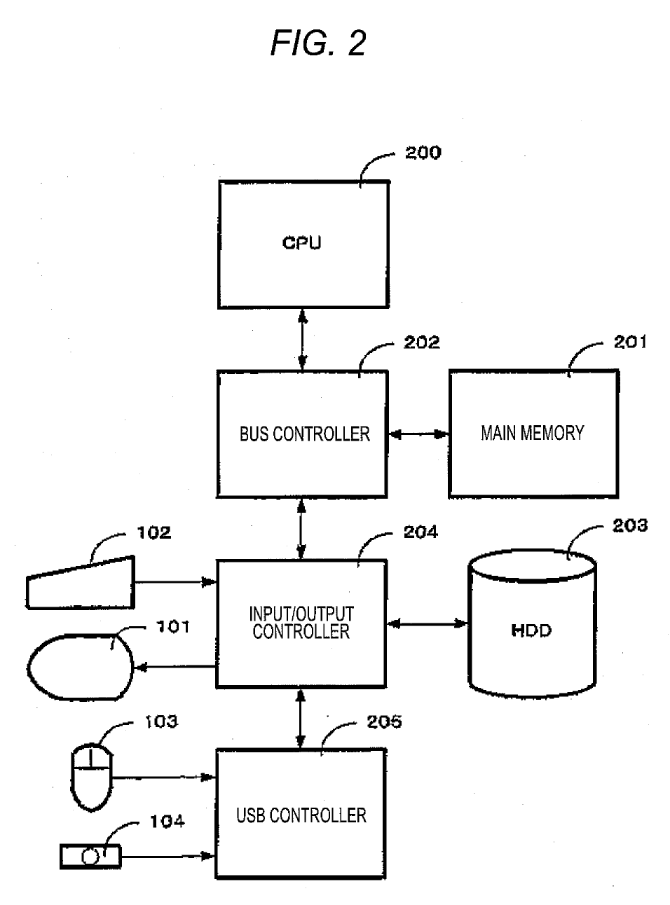

FIG. 2 is a block diagram showing one example of the authentication device according to the embodiment. In FIG. 2, a CPU 200, a main memory 201, a bus controller 202, an HDD 203, an input/output controller 204 and a USB controller 205 are shown.

The CPU 200 is a central processing unit (Central Processing Unit) for controlling the overall information apparatus 100. Also, it has a function of executing a program to perform a predetermined processing according to the program.

The main memory 201 is composed of a semiconductor memory, and used as a storage area of program and data when the CPU 200 performs a program.

The bus controller 202 has a function of controlling a bus for conveying information between the components of the information apparatus 100. An instruction from the CPU 200 reads or writes data from or into the main memory 201 via the bus, or gives an instruction to another apparatus.

The HDD 203 is a mass storage unit composed of a magnetic disk unit (Hard Disk Drive), for example. It stores an application performed by the CPU 200 or data required during execution, which is passed via the bus controller 202 to the CPU 200, as needed.

The input/output controller 204 has a function of providing the interface with the CPU 200, the HDD 203, and various kinds of input/output units such as the display unit 101 and the keyboard 102.

The USB controller 205 is a control unit for connecting the apparatus having the interface conforming to the USB (Universal Serial Bus) standards. Various apparatuses conforming to the USB standards have appeared, and can be freely connected or disconnected even while the information apparatus 100 is operating with a PnP (Plug and Play) technology. In this embodiment, it is employed to connect the mouse 103 and the camera 104.

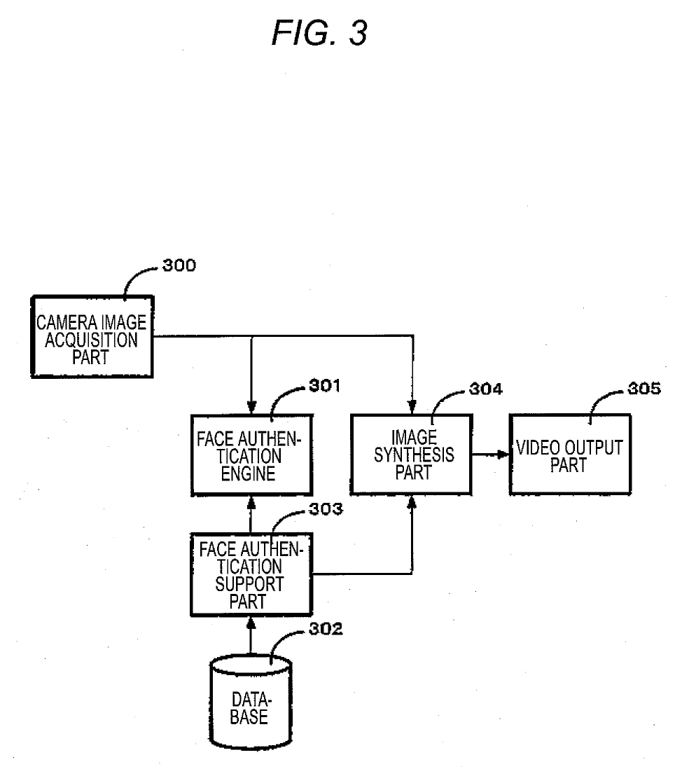

FIG. 3 is a functional block diagram showing one example of the authentication device according to the embodiment. In FIG. 3, a camera image acquisition part 300, a face authentication engine 301, a database 302, a face authentication support part 303, an image synthesis part 304 and a video output par 305 are shown.

The camera image acquisition part 300 has a function of acquiring a video captured by the camera 104 as image data. For example, the driver software of the camera 104 corresponds to this.

The face authentication engine 301 has a function of inputting a face image of the user acquired by the camera video acquisition part 300 and specifying the person with the face. Several methods for identifying the specific person from the face image are known, but not described here in detail. Generally, to specify the specific person from the face image, the face image is photographed in advance, and the feature points contained therein are extracted. In the authentication, a process for extracting the feature points of the face image photographed by the camera, and collating them with the feature points stored beforehand is performed.

In the face authentication, when the user faces sideways, has a shade due to the influence of illumination, or unsteadily move, they are all noise, possibly degrading the face authentication accuracy. At this time, the accuracy of face authentication can be improved by storing beforehand the feature points extracted from the face images in plural directions, not the feature points of the face image in only one direction such as facing forward, and collating them with the face images oriented in respective directions.

The database 302 is the database of the HDD 203, for example, storing the guide image. The guide image as used herein refers to the image representing to which direction the user has the face turned in the face authentication. The guide image is superimposed on the camera image photographed by the camera 104 and displayed on the display 101. The details of the guide image will be described later.

The face authentication support part 303 has a function of supporting the face authentication operation, or acquiring the guide image for instructing the user in front of the camera 104 to turn the face right from the database 302, when it is desired to make the face authentication using the face image turning right, for example. Further, it instructs the face authentication engine 301 to make the authentication for the acquired camera image, using the feature points of the face turning right. When there are guide images in plural directions and the feature points of the face images oriented in plural directions, the instructions for acquiring the guide image and authentication may be repeated for respective directions. With this constitution, the comparison with the feature points of plural face images can be made for one user, whereby the face recognition ratio is improved.

The image synthesis part 304 has a function of synthesizing the camera image acquired by the camera image acquisition part 300 and the guide image acquired by the face authentication support part 303, if any, to generate one image,

The video output part 305 has a function of outputting the composite image generated by the image synthesis part 304 to display it on the display 101. For example, a display driver or a GUI (Graphical User Interface) corresponds to this.

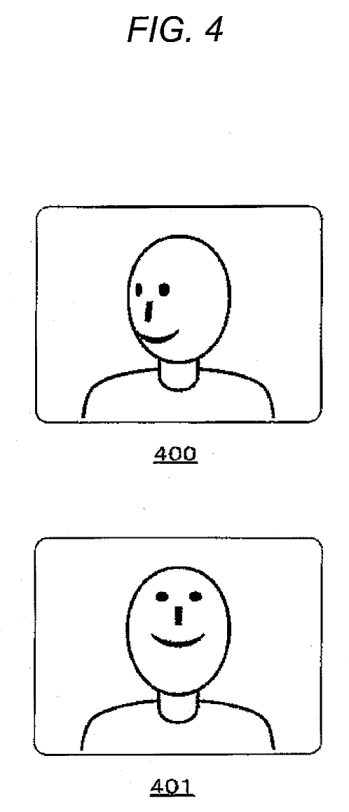

FIG. 4 is a view showing an example of the guide image according to the embodiment. A face image 400 is an example of the image in which an illustration of the person facing right is drawn, and instructs the user, while seeing this image, to make a confirmation in front of the camera 104 so that the user may be reflected in the same orientation or at the same position of the illustration of the image as this image. Similarly, a face image 401 instructs the user to face front toward the camera 104. In addition to the instruction of this case, other instructions for turning the face such as up or down, right or left, or diagonal or inclined direction may be prepared, as needed. Or the guide image for instructing the user to put on or off the glasses or furnishings, or the guide image representing the instruction for coming closer to or leaving away from the camera may be prepared. With this configuration, the user seeing this guide image can easily understand intuitively which direction to turn the face.

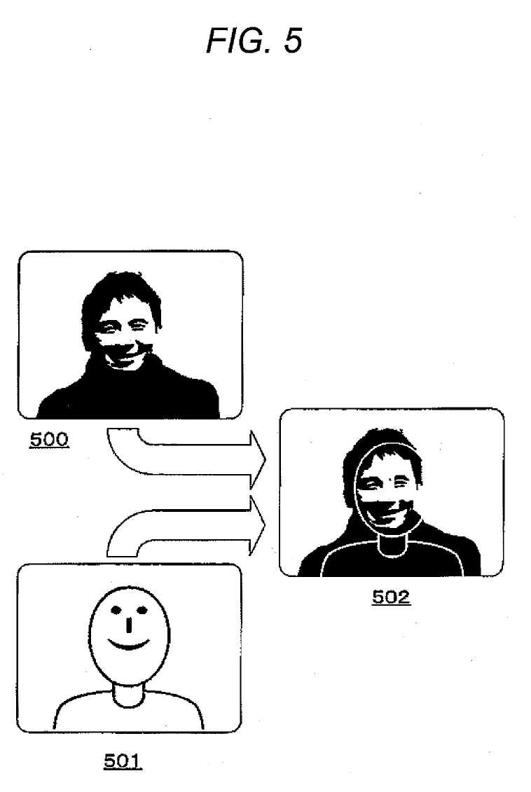

FIG. 5 is a view showing an example of image synthesis according to the embodiment. At the time of face authentication, it is supposed that if there is a camera image 500 captured by the camera 104, the face authentication support part 303 acquires a guide image 501 representing facing forward from the database 302 to make the face authentication in the forward direction. The image synthesis part 304 receives the camera image 500 acquired by the camera image acquisition part 300 and the guide image 501 acquired by the face authentication support part 303, and outputs a synthesized image 502 to the video output part 305 to display it on the display 101.

Since the guide image 501 is synthesized with the camera image 500 and displayed on the display 101, the use can easily know to which direction to turn the face while seeing the display 101, or how much to come closer to the camera 104 by making the comparison with the size of the guide image 501.

During face authentication, the user continues to face in the direction toward the camera 104 laid on the top of the display 101, and can easily confirm the motion of his or her own.

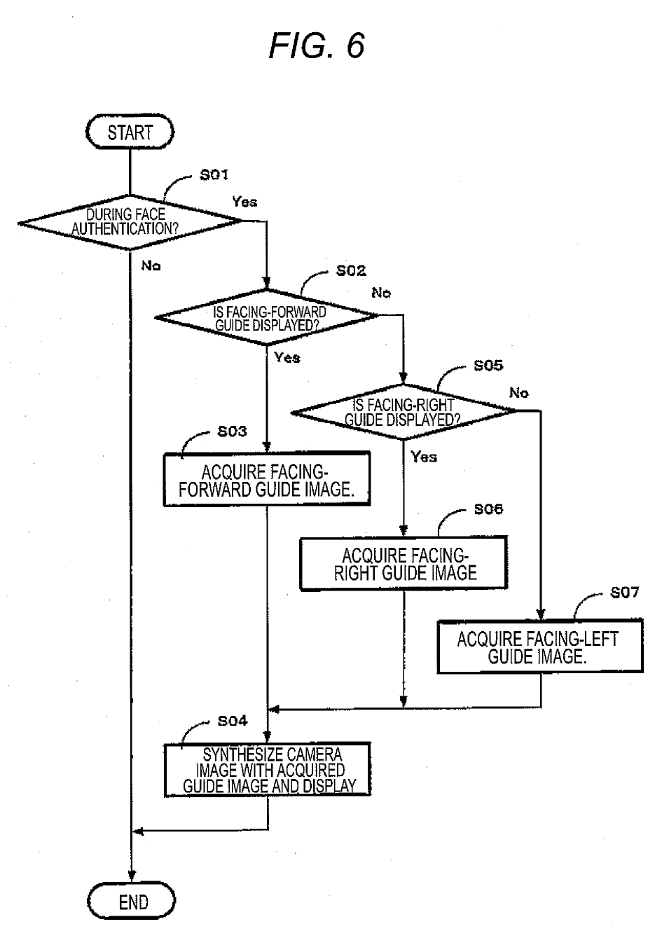

FIG. 6 is a flowchart showing one example of operation flow of the authentication device according to the embodiment.

First of all, it is judged whether or not the face authentication engine 301 is during face authentication (step S01).

If the face authentication engine 301 is during face authentication (Yes), it is judged whether or not the face authentication support part 303 makes the face authentication using the feature points of the face image of the user with the attribute of facing forward (step S02).

If the face authentication is made using the face image with the attribute of facing forward (Yes), the face authentication support part 303 acquires the guide image representing facing forward from the database 302 (step S03). After acquisition, the image synthesis part 304 synthesizes the camera image acquired by the camera image acquisition part 300 with the guide image, and the video output part 305 displays the composite image on the display 101 (step S04).

If the face authentication with the attribute of facing forward is not made at step S02 (No), it is judged whether or not the face authentication involves the attribute of facing right (step S05).

If the face authentication involves the attribute of facing right (Yes), the guide image representing facing right is acquired from the database 302 (step S06), and the composite image is displayed on the display 101 (step S04).

If the face authentication does not involve the attribute of facing right (No), the guide image representing facing left is acquired (step S07), judging that the face authentication involves another attribute of facing left, and the composite image is displayed (step S04).

With this configuration, in the face authentication, it is possible to support the user with an instruction accompanying motion to the position or orientation of the user's face to be reflected without averting the light of sight from the camera.

The invention is by no means limited to the above embodiment, but may be embodied in other forms by varying the components without departing from the spirit or scope of the invention at the practical stage. Also, various inventions may be formed by making appropriate combinations of plural components as disclosed in the above embodiment. For example, some of the components may be deleted from all the components as shown in the embodiment. Further, the components in different embodiments may be appropriately combined.

As described with reference to the embodiment, there is provided an authentication device, an authentication method and an authentication program that can support the user with an instruction accompanying motion to the position or orientation of the user's face to be reflected without averting the line of sight from the camera in trying to enhance the authentication accuracy using the face images oriented in plural directions.

It is possible to provide an authentication device, an authentication method and an authentication program that can support the user with an instruction accompanying motion for instructing the position or orientation of the user's face to be reflected without averting the line of sight from the camera in making the face authentication.

What is claimed is:

1. An authentication apparatus for authenticating an authentication target by a face comprising:
a display configured to display an image to authentication target;
a camera next to the display, configured to capture an image of the authentication target;
an assistance display module configured to display a guide image instructing a direction of the face in accordance with an attribute of the authenticating; and
an image synthesizer configured to synthesize the image captured by the camera and the guide image displayed by the assistance display module, and to display a synthesized image on the display.

2. The authentication device of claim 1, wherein the guide image comprises a plurality of images each comprising an image of human figure facing in a given direction.

3. The authentication device of claim 2, wherein a size of the guide image is substantially the same as the size of the authentication target suitable for authentication in the image captured by the camera.

4. An authentication method for authenticating an authentication target by a face comprising:
selecting a guide image instructing a direction of the face in accordance with an attribute of the authenticating;
capturing a face image of the authentication target;
generating a synthesized image from the face image and the selected guide image; and
displaying the synthesized image.

5. The authentication method of claim 4, wherein the guide image comprises a plurality of images each comprising an image of human figure facing in a given direction.

6. The authentication method of claim 5, wherein a size of the guide image is substantially the same as the size of the authentication target suitable for authentication in the face image.

7. A computer readable storage medium comprising a software program configured to cause a computer system to perform an authentication process for authenticating an authentication target by a face, the process comprising:
selecting a guide image instructing a direction of the face in accordance with an attribute of the authenticating;
capturing a face image of the authentication target;
generating a synthesized image from the face image and the selected guide image; and
displaying the synthesized image.

8. The computer readable storage medium of claim 7, wherein the guide image comprises a plurality of images each comprising an image of human figure facing in a given direction.

9. The computer readable storage medium of claim 8, wherein a size of the guide image is substantially the same as the size of the authentication target suitable for authentication in the face image.
